(19) United States
(12) Patent Application Publication
(10) Pub. No.: US 2010/0170625 A1
(43) Pub. Date: Jul. 8, 2010

(54) FASTENER AND A MANUFACTURE PROCESS THEREOF

(75) Inventors: Jiqiao Liao, Changsha (CN); Weiping Tai, Yiyang (CN); Yuejun Wang, Changsha (CN); Yuliang Gong, Yiyang (CN)

Correspondence Address: KNOBBE MARTENS OLSON & BEAR LLP, 2040 MAIN STREET, FOURTEENTH FLOOR, IRVINE, CA, 92614, US

(73) Assignee: HUNAN KINGBO CARBON-CARBON COMPOSITES CO. LTD., Yiyang, Hunan (CN)

(21) Appl. No.: 12/602,982

(22) PCT Filed: Sep. 2, 2008
(86) PCT No.: PCT/CN08/72238

§ 371 Date: Dec. 3, 2009

(30) Foreign Application Priority Data
Jul. 4, 2007 (CN) 200720063746.2
Jan. 10, 2008 (CN) 200810030470.7

(51) Int. Cl. F16B 33/00; C04B 35/52; F16B 35/00

(52) U.S. Cl. 156/148; 29/527.2

(57) ABSTRACT

The invention discloses a fastener made from a carbon/carbon composite and a manufacturing technique thereof. The fastener can be adopted in a high-temperature furnace or corrosive environment to replace a graphite fastener or a molybdenum fastener, and is made from carbon fiber via the steps of felt making, densifying, plastifying modification, machining and purifying.

### CROSS-REFERENCE TO RELATED APPLICATIONS

This Application is a U.S. National Phase under 35 U.S.C. §371 of International Application No. PCT/CN2008/072238 filed Sep. 2, 2008 designating the U.S. and published on Jan. 8, 2009 as WO 2009/003424, which claims priority to Chinese Patent Application No. 200810030470.7, filed Jan. 10, 2008.

### BACKGROUND OF THE INVENTION

1. Field of the Invention

The invention relates to a part for a high-temperature furnace or corrosive environment, more particularly to a fastener and a manufacturing technique thereof.

2. Background Information

At present, the heater of a high-temperature metallurgical furnace is in general composed of a heating body, a connection block and a fastener, the material thereof is graphite and has the problem of, when used, losing effectiveness frequently due to the cracking caused by inferior mechanical properties of a graphite screw, thus resulting in the heater falling apart and leading to production halt or accidents, which severely impact the normal production. The service life of some these heaters is only more than ten days. A crucible support of a polycrystalline furnace is composed of a graphite plate and the graphite screw, wherein the graphite screw often cracks owing to the action of a thermal stress. The service life of some the crucible supports is only a few days, which increases the production cost. Furthermore, the ash dropping from the graphite articles leads to hands being blackened when the graphite articles are handled; when being used, the graphite articles lead to pollution of environment, other parts, raw materials and end products, and affect the purity and quality of the products. A molybdenum screw used in the high-temperature metallurgical furnace is sintered in most cases after being used for a while in a high-temperature environment, the screw rod and the screw hole are stuck together and became a whole, making it difficult to be disassembled, causing inconvenience to the maintenance of the furnace and increasing the maintenance cost.

The carbon/carbon composite is formed by the steps of compositing web and web, or carbon cloth and carbon cloth, or web and carbon cloth, all of which are made of carbon fiber, and then densifying, carbonizing and graphitizing the same. The carbon/carbon composite has the excellent properties, such as high specific strength, high specific modulus, high-temperature resistance, ablation resistance, low coefficient of heat expansion, snap cooling or heating resistance thus being free from deformation and cracking. These properties make carbon/carbon composite particular suitable for the field of high temperature and has been or will progressively become one of the most fundamental materials in the fields of aero-space, metallurgy, new energy and the like. When the carbon/carbon composite is applied to manufacturing the fastener, and it is an ideal alternative for the graphite fastener and the molybdenum fastener.

The carbon fiber is divided, in accordance with different raw materials thereof, into polyacrylonitrile-based carbon fiber, viscose glue-based carbon fiber and asphaltum-based carbon fiber. The former carbon fiber dominates at present, hence, the generally-referred carbon fiber is the polyacrylonitrile-based carbon fiber made by polyacrylonitrile fiber. The carbon fiber is divided, in accordance with the different quantities of fiber filaments contained in filament bundles thereof, into 1 k, 3 k, 6 k, 12 k, 24 k, 50 k and the like, wherein, k is a unit of quantity, representing 1000 filaments.

The carbon cloth is formed by weaving the filament bundles of the carbon fiber may have an areal density of 200 g/m², 220 g/m², 240 g/m², or 260 g/m², which is the weight in grams per square meter of the carbon cloth.

Needling is a known non-woven fabric and weaved felt process, which is processed by puncturing adjacent cloth and webs via a needle with a barb. When the needle punctures, the barb on the needle hooks on part of the web fiber, which move along with the needle to create a displacement. Meanwhile, the cloth and the webs are compressed. When the needle punctures to a certain depth, the needle rises, and at this moment, as the barb is in a positive direction, the fiber hooked on to the barb is disengaged from the barb to be retained inside the felt in a nearly perpendicular state, so as to incorporate the fiber in a perpendicular direction to form a quasi-three-dimensional structure. The web is a batt-like carbon fiber web formed by cutting the carbon fiber into 10-80 mm of short fibers to be subjected to mechanical opening and air-laying. The needling process has been applied universally in the non-woven industry.

### SUMMARY OF THE INVENTION

One objective of the inventive is to provide a fastener made from carbon/carbon composite and a manufacturing technique thereof. The fastener may be a screw, a bolt, a double-screw bolt, screw nuts and a gasket. The fastener can be adopted in a high-temperature furnace or corrosive environment to replace a graphite fastener or a molybdenum fastener.

One embodiment provides a method of manufacturing a fastener comprising overlapping web and web, carbon cloth and carbon cloth or web and carbon cloth together and needling or puncturing to obtain a felt, densifying the felt by chemical vapor infiltration and/or liquid immersion to obtain the a densified felt, immersing the densified felt into a resin adhesive solution to form a carbon/carbon composite, machining the carbon/carbon composite into a fastener, and heating the fastener in a high temperature under vacuum condition.

### BRIEF DESCRIPTION OF THE DRAWINGS

FIG. 1 is a structural schematic diagram of a double-screw bolt 3 and a nut 4.

FIG. 2 is a structural schematic diagram of a bolt 2 and a nut 4.

FIG. 3 is a structural schematic diagram of a screw 1.

### DESCRIPTION OF THE PREFERRED EMBODIMENTS

A fastener is made from carbon fiber via the steps of felt making, densifying, plastifying modification, machining and purifying. The inventive fastener may be a screw, a bolt, a double-screw bolt, screw nuts and a gasket.

The inventive manufacturing technique of the fastener comprises the following steps:
(1) Felt making: web and web, or carbon cloth and carbon cloth or web and carbon cloth, which are made of carbon fiber, are overlapped and placed to the required thickness, and then are composited by needling or puncturing so as to obtain the required carbon/carbon composite felt;
(2) Densifying: the felt obtained from the step (1) is densified by means of chemical vapor infiltration (deposition) and/or liquid immersion to obtain the required carbon carbon composite;
(3) Plastifying modification: the carbon/carbon composite obtained from step (2) is immersed into a resin adhesive solution;
(4) Machining: the carbon/carbon composite obtained from step (3) is machined into a fastener with required shape and size;
(5) Purifying: the fastener obtained from step (4) is put into a high-temperature furnace and then heated in a vacuum condition so as to remove the impurities therein.

As an improvement of the invention, step (6) of cleaning is performed after step (5): namely, the fastener is well washed to clean the surface thereof without ashes or any dirt and is then dried; step (7) of the surface treatment is performed after step (6), namely, the fastener is placed in the CVD furnace for chemical vapor deposition; the fastener is subjected to surface treatment at a temperature ranging from 800° C. to 1100° C. in an atmosphere of propylene and/or natural gas in the chemical vapor deposition furnace.

The invention in the step (1) has the areal density of the web of 30-130 g/m², the needling depth of 15-30 mm, the needling density of 3-10 times/cm², and the density of the carbon cloth of 120-300 g/m², the layer density of 7-30 layers/cm.

The invention in step (2) has the density of the densified felt of 1.1-1.8 g/m³.

The invention in step (3) has the immersion time of 10-90 minutes.

As the technical proposal is employed, the invention preferably achieves the inventive objective. Because the carbon fiber composite material has a quasi three-dimensional internal structure, the processed fastener has higher specific strength and lower thermal expansion coefficient, can avoid deformation and cracking caused by snap cooling or heating, and has a flexural strength ten times that of graphite, such that the fastener hardly cracks under the action of external forces or in the working environment of snap cooling or heating, the service life thereof is prolonged greatly, which can reach more than one year. Further, because the carbon fiber composite material has the lubricating property similar to graphite, the fastener can be easily assembled or disassembled. After a surface treatment, the fastener has a cleaned surface without dust falling-off, thereby avoiding pollution to the environment, other parts, raw materials and end products.

Further description is given to the invention with the accompanying figures.

### EMBODIMENT 1

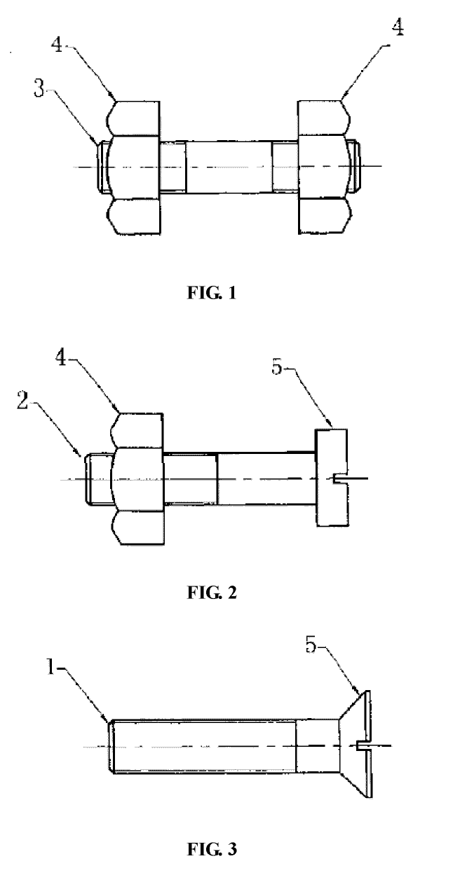

The double-screw bolt 3 in FIG. 1 can be manufactured to have equal diameter, namely, the diameter and size of each section are substantially consistent with each other. The double-screw bolt can also be manufactured to have unequal diameters. The double-screw bolt has screw threads at two ends, and is used with the screw nuts 4. When used, the connected member is clamped by the screw nuts 4 or clamping plates at both ends. The screw nuts 4 can be produced in a shape of round, square, hexagon and curved triangle (the hexagon is shown in the embodiment).

The manufacturing technique comprises the following the steps:

(1) Felt making:

Opening and web laying: short carbon fiber which is 6-70mm long is selected and opened by an opening apparatus to a loosened single fiber, and then the opened carbon fiber is subjected to air-laying and carding to lay a fiber web by using a lapping machine followed by being pre-needled to a web. The areal density of the web is 30-130 g/m² (100 g/m² in this embodiment) The carbon cloth is formed by weaving the carbon fiber bundles, and the density of the carbon cloth is 120-300 g/m² (230 g/m² in this embodiment).

Overlapping composition: the resultant web is laid on a working bench on which a layer of the carbon cloth is laid, another layer of the web is laid on the carbon cloth for being composited by the needling. The needling depth is 15-30 mm (23 mm in this embodiment); the needling density is 3-10 times/cm² (9 times in this embodiment); the layer density is 7-30 layers/cm (12 layers/cm in this embodiment). Such operations are repeated to manufacture the required carbon/carbon composite felt. Or the web and the carbon cloth are overlapped and stacked to the required thickness to manufacture the required carbon/carbon composite felt by the needling.

The web and web, or carbon cloth and carbon cloth can also be employed to manufacture the required carbon/carbon composite felt by the needling or puncturing.
(2) Densifying: the felt obtained in step (1) is densified to the carbon/carbon composite material. The densifying process includes, but not limited to, chemical vapor infiltration (deposition) and/or liquid immersion, such that the density thereof is increased gradually and carbonized (if needed) and graphitized, the prefabricated member is processed to the carbon carbon composite material having a density of 1.1 g/m³-1.8 g/m³ (1.5 g/m³ in this embodiment);
(3) Plastifying modification: the resultant carbon/carbon composite material obtained in the step (2) is immersed into a resin adhesive solution (e.g., an epoxy resin adhesive solution in this embodiment) with an immersion time of 10-90 minutes (35 minutes in this embodiment), which strengthens the plasticity thereof, improves processing performance thereof and eradicates filament burst phenomenon. The invention can also employ alkyd resin, acrylic resin and the like.
(4) Machining: the plastifying modified carbon/carbon composite material obtained from step (3) is machined into the required double-screw bolt 3 and screw nuts 4.
(5) Purifying: the fastener obtained in step (4) is placed in the high-temperature furnace and heated to 800° C. to 1600° C. under vacuum conditions (1200° C. in this embodiment), followed by heat preservation for 60-360 minutes (200 minutes in this embodiment) to remove the impurities therein.

In order to clean the surface of the fastener without ash and dirt, an additional step (6) of cleaning is added: namely, the double-screw bolt 3 and screw nuts 4 are well washed and dried.

In order to keep the surface of the double-screw bolt 3 and screw nuts 4 clean without dust falling off, to not pollute the surrounding environments when used and to not stick and blacken hands when held by the hands, step (7) of surface treatment is added. Namely, the double-screw bolt 3 and screw nuts 4 are placed in the CVD furnace for the chemical vapor deposition. Namely, the double-screw bolt 3 and screw nuts 4 are subjected to the surface treatment at a temperature ranging from 800° C. to 1100° C. (900° C. in this embodiment) in an atmosphere of propylene and/or natural gas (propylene in the embodiment).

In accordance with the operating requirement, the double-screw bolt 3 and screw nuts 4 subjected to step (5) can also be used directly without being subjected to step (6) and step (7).

### EMBODIMENT 2

The bolt 2 in the FIG. 2 has screw thread at one end which is usually used in cooperation with the screw nuts 4 to clamp the connected member. In another embodiment, the bolt can be used without the nuts 4. The screw thread part thereof is directly screwed into a thread hole of one of the connected member to integrate the connected members as a whole. The screw head 5 can be manufactured in a shape of round, square, hexagon and curved triangle, the head thereof can be provided with a slotted groove or a crossed groove (the screw head 5 in this embodiment is round with the slotted groove provided at the head thereof). The manufacturing technique comprises the following steps:

In step (2), the embodiment employs the immersion and densifying processes to densify the density thereof to 1.7 g/cm³. In step (3), the embodiment employs unsaturated polyester resin.

The rest of the steps are identical to embodiment 1.

### EMBODIMENT 3

The screw 1 in the FIG. 3 does not require the nuts 4 in general, the screw thread part is directly screwed into the screw hole of one of the connected member to connect the connected members. The screw thread part can also be used in cooperation with the nuts 4 to connect the connected members. The screw head 5 is divided into countersunk head, round head and square head, the heads of the countersunk head screw and the round head screw are provided with the slotted grooves or the crossed grooves (the screw head 5 in this embodiment is the countersunk head with the slotted groove provided at the head thereof). The manufacturing technique comprises the following steps:

In the step (2), the embodiment employs the chemical vapor deposition process to densify, the density is 1.3 g/cm³. In the step (3), the embodiment employs urea-formaldehyde resin.

The rest of steps are identical to embodiment 1.

1-10. (canceled)

11. A method of manufacturing a fastener comprising:
overlapping web and web, carbon cloth and carbon cloth or web and carbon cloth together and needling or puncturing to obtain a felt;
densifying the felt by chemical vapor infiltration and/or liquid immersion to obtain the a densified felt;
immersing the densified felt into a resin adhesive solution to form a carbon/carbon composite;
machining the carbon/carbon composite into a fastener; and
heating the fastener in a high temperature under vacuum condition.

12. The method of claim 15, further comprising washing the fastener.

13. The method of claim 16, further comprising subjecting the fastener to a chemical vapor deposition.

14. The method of claim 17, wherein the chemical vapor deposition is performed at a temperature of 800 to 1100° C. in an atmosphere of propylene and/or natural gas.

15. The method of claim 15, wherein the web has an areal density of 30 to 130 g/m², and the carbon cloth has a density of 120 to 300 g/m².

16. The method of claim 15, wherein the needling is characterized by a needling depth of 15 to 30 mm and a needling density of 3 to 10 times/cm².

17. The method of claim 15, wherein the felt has a layer density of 7-30 layers/cm.

18. The method of claim 15, wherein the densified felt has a density of 1.1 to 1.8 g/m³.

19. The method of claim 15, wherein the time for immersing the densified felt into resin adhesive solution is 10 to 90 minutes.
